(19) United States
(12) Patent Application Publication
(10) Pub. No.: US 2008/0149284 A1
(43) Pub. Date: Jun. 26, 2008

(54) BLIND DEVICE

(76) Inventor: Ya-Yin Lin, Chia-Yi Hsien (TW)

Correspondence Address: CHRISTIE, PARKER & HALE, LLP, PO BOX 7068, PASADENA, CA, 91109-7068, US

(21) Appl. No.: 11/681,155

(22) Filed: Mar. 1, 2007

(30) Foreign Application Priority Data
Dec. 20, 2006 (TW) 095222431

(51) Int. Cl. E06B 9/26

(52) U.S. Cl. 160/377

(57) ABSTRACT

A blind device includes a flexible screen body with interconnected shielding sections, and a counterweight unit provided on a lowermost one of the shielding sections. The counterweight unit includes vertically extending left and right side bars provided respectively at left and right edges of the lowermost shielding section, and a horizontally extending bottom bar retained at a bottom edge of the lowermost shielding section, which includes two vertically extending flaps extending respectively from left and right edges of a main shielding part. Each of the flaps is coupled removably to the main shielding part to form a pocket when coupled thereto. The left and right side bars are received respectively and removably in the pockets so as to stretch the lowermost shielding section when received in the pockets and to permit folding of the lowermost shielding section in the vertical direction when removed from the pockets.

### CROSS-REFERENCE TO RELATED APPLICATION

This application claims priority of Taiwanese Application No. 095222431, filed on Dec. 20, 2006.

### BACKGROUND OF THE INVENTION

1. Field of the Invention

The invention relates to a blind device, more particularly to a blind device having a screen body that can be furled and unfurled, and that can be held at an arbitrary height.

2. Description of the Related Art

A conventional blind device includes a flexible screen body that can be furled and unfurled, and a counterweight unit provided on the screen body to balance the winding force of a winding mechanism. Since the counterweight unit of the conventional blind device is provided fixedly on the screen body and is not foldable, packaging material and storage space requirements of the conventional blind device are large.

### SUMMARY OF THE INVENTION

Therefore, the object of the present invention is to provide a blind device having a screen body that can be furled and unfurled, and a counterweight unit with components that can be removed from the screen body to facilitate easy assembly and disassembly of the blind device, and to reduce packaging material and storage space requirements of the blind device.

According to the present invention, there is provided a blind device that includes a top frame member, a flexible screen body, a plurality of lifting rods, a furling controller, and a counterweight unit. The flexible screen body can be furled and unfurled, and has a top end connected to the top frame member. The screen body includes a plurality of shielding sections arranged in a vertical column. Adjacent ones of the shielding sections are interconnected. Each of the lifting rods is retained at a junction of a corresponding adjacent pair of the shielding sections of the screen body. The furling controller includes a winding mechanism mounted on the top frame member, and at least one pull cord connected to the winding mechanism and to the lifting rods in sequence. The pull cord has a distal end retained at a top of a lowermost one of the shielding sections. The winding mechanism applies a winding force on the pull cords. The counterweight unit is provided on the lowermost one of the shielding sections to balance the winding force of the winding mechanism.

The counterweight unit includes vertically extending left and right side bars provided respectively at left and right edges of the lowermost one of the shielding sections, and a horizontally extending bottom bar retained at a bottom edge of the lowermost one of the shielding sections and disposed to transmit an upward pushing force on the bottom bar to the left and right side bars. The counterweight unit is convertible from a screen-stretching state, where the lowermost one of the shielding sections is stretched by the left and right side bars, and a screen-foldable state, where the counterweight unit permits folding of the lowermost one of the shielding sections in a vertical direction.

The lowermost one of the shielding sections includes a main shielding part that has the left and right edges, and a pair of vertically extending flaps that extend respectively from the left and right edges. Each of the vertically extending flaps is coupled removably to the main shielding part and forms a corresponding vertically extending pocket at a corresponding one of the left and right edges when coupled to the main shielding part. The left and right side bars are received respectively and removably in the vertically extending pockets such that the left and right side bars stretch the lowermost one of the shielding sections when received in the vertically extending pockets and permit folding of the lowermost one of the shielding sections in the vertical direction when removed from the vertically extending pockets.

### BRIEF DESCRIPTION OF THE DRAWINGS

Other features and advantages of the present invention will become apparent in the following detailed description of the preferred embodiments with reference to the accompanying drawings, of which:

FIG. 1 is a rear perspective view of the first preferred embodiment of a blind device according to the present invention;

FIG. 2 is a fragmentary exploded perspective view of the first preferred embodiment, illustrating a counterweight unit and a lowermost shielding section of a screen body;

FIG. 3 is a fragmentary sectional view of the first preferred embodiment, illustrating assembly relationship among a side bar, a bottom bar, a lowermost lifting rod, and a coupler;

FIG. 4 is a side view of the first preferred embodiment, illustrating the screen body when folded while the counterweight unit is disposed at a screen-foldable state;

FIG. 5 is a fragmentary exploded perspective view of the second preferred embodiment of a blind device according to the present invention, illustrating configuration of the counterweight unit and the lowermost lifting rod; and

FIG. 6 is a fragmentary rear perspective view of the third preferred embodiment of a blind device according to the present invention, illustrating a coupling unit thereof.

### DETAILED DESCRIPTION OF THE PREFERRED EMBODIMENTS

Before the present invention is described in greater detail, it should be noted herein that like elements are denoted by the same reference numerals throughout the disclosure.

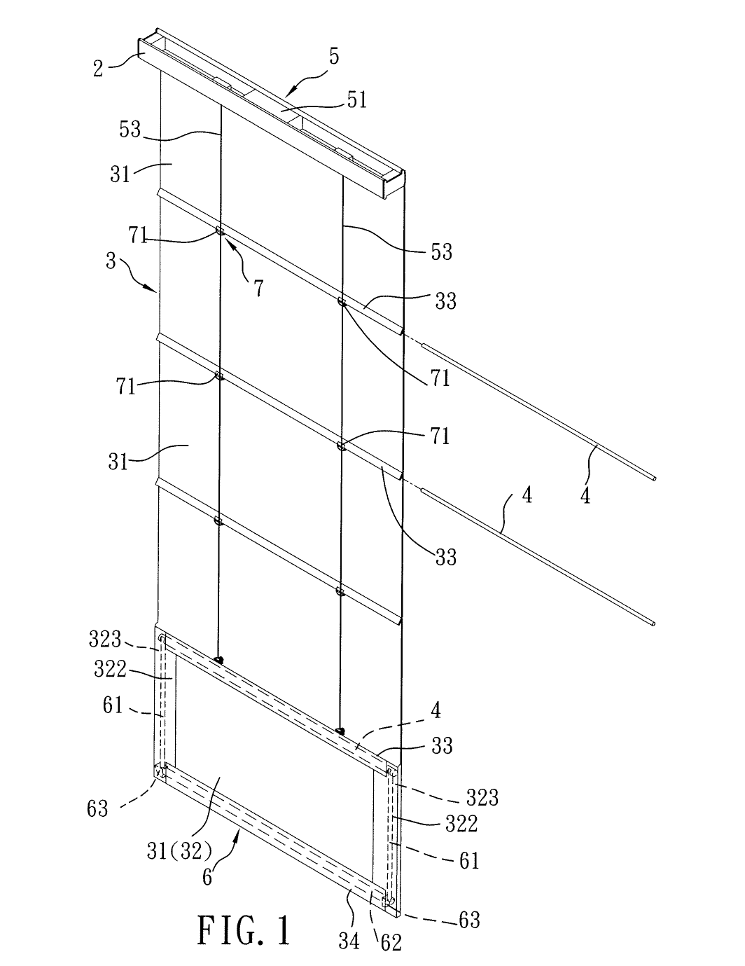

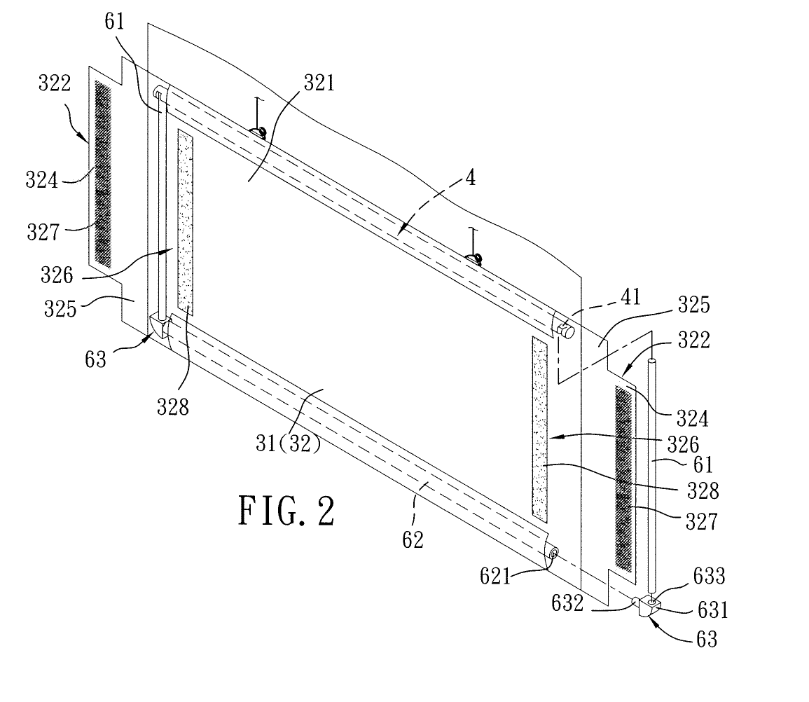

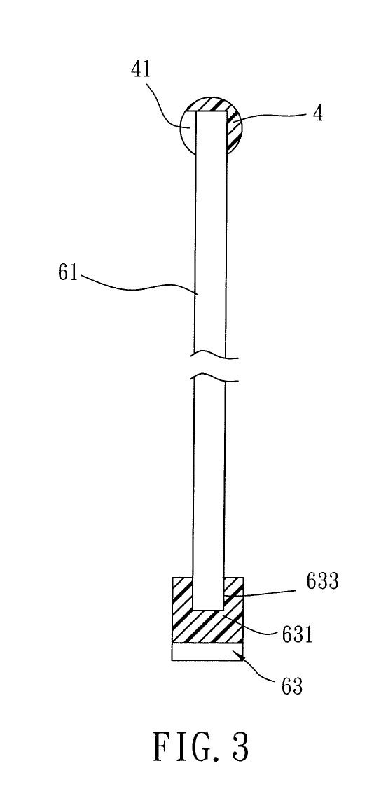

As shown in FIG. 1, FIG. 2 and FIG. 3, the first preferred embodiment of a blind device according to the present invention includes a top frame member 2, a flexible screen body 3 that can be furled and unfurled and that has a top end connected to the top frame member 2, a plurality of lifting rods 4 provided on the screen body 3, a furling controller 5 mounted on the top frame member 3 and operable to furl the screen body 3, and a counterweight unit 6 provided on a lowermost part of the screen body 3.

The screen body 3 includes a plurality of shielding sections 31 arranged in a vertical column. Adjacent ones of the shielding sections 31 are interconnected. The screen body 3 is provided with a plurality of horizontally extending rod-receiving pockets 33, each of which is disposed at a junction of a corresponding adjacent pair of the shielding sections 31. A lowermost one of the shielding sections 31, which is referred to hereinafter as the lowermost shielding section and is denoted by reference numeral 32, is provided with a horizontally extending pocket 34 at a bottom edge thereof. In this embodiment, the screen body 3 is made from a fabric material, includes five of the shielding sections 31, and is provided with four of the rod-receiving pockets 33. The rod-receiving pockets 33 are formed by folding, followed by sewing, at junctions of the shielding sections 31. The horizontally extending pocket 34 is formed by folding, followed by sewing, at the bottom edge of the lowermost shielding section 32.

Each of the lifting rods 4 is retained at a junction of a corresponding adjacent pair of the shielding sections 31 of the screen body 3. In this embodiment, there are four of the lifting rods 4 (only two are visible in FIG. 1), and the lifting rods 4 are received in the horizontally extending rod-receiving pockets 33, respectively.

The counterweight unit 6 is provided on the lowermost shielding section 32 of the screen body 3 to balance the winding force of the winding mechanism 5. The counterweight unit 6 includes vertically extending left and right side bars 61 provided respectively at left and right edges of the lowermost shielding section 32, and a horizontally extending bottom bar 62 retained at a bottom edge of the lowermost shielding section 32 and disposed to transmit an upward pushing force on the bottom bar 62 to the left and right side bars 61. The bottom bar 62 is received in the horizontally extending pocket 34 of the lowermost shielding section 32 of the screenbody 3. The counterweight unit 6 further includes a pair of couplers 63, each of which connects removably a corresponding one of left and right ends of the bottom bar 62 to a lower end of a corresponding one of the left and right side bars 61.

The lowermost shielding section 32 includes a main shielding part 321 that has the left and right edges, and a pair of vertically extending flaps 322 extending respectively from the left and right edges. Each of the vertically extending flaps 322 is coupled removably to the main shielding part 321 and forms a corresponding vertically extending pocket 323 at a corresponding one of the left and right edges when coupled to the main shielding part 321. The lowermost shielding section 32 further includes two coupling units 326 for coupling removably the vertically extending flaps 322 to the main shielding part 321. The left and right side bars 61 of the counterweight unit 6 are received respectively and removably in the vertically extending pockets 323.

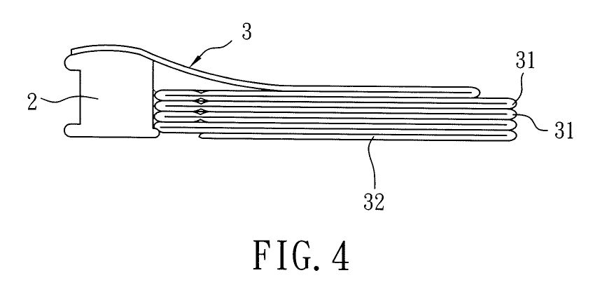

The counterweight unit 6 is convertible from a screen-stretching state (as shown in FIG. 1), where the lowermost shielding section 32 is stretched by the left and right side bars 61, and a screen-foldable state (as shown in FIG. 4), where the counterweight unit 6 permits folding of the lowermost shielding section 32 in a vertical direction. When the left and right side bars 61 are received in the vertically extending pockets 323, the counterweight unit 6 is disposed at the screen-stretching state. When the left and right side bars 61 are removed from the vertically extending pockets 323, the counterweight unit 6 is disposed at the screen-foldable state. When the counterweight unit 6 is disposed at the screen-stretching state, the rectangular structure formed cooperatively by the left and right side bars 61, the bottom bar 62, the couplers 63, and a lowermost one of the lifting rods 4 (referred to hereinafter by the lowermost lifting rod 4) maintains the lowermost shielding section 32 at the stretched state.

As shown in FIG. 2 and FIG. 3, the lowermost lifting rod 4 is exposed from the corresponding rod-receiving pocket 33, i.e., the lowermost rod-receiving pocket 33, at opposite ends thereof. The lowermost lifting rod 4 is formed with two slots 41 at the opposite ends thereof to engage removably upper ends of the left and right side bars 61. The bottom bar 62 of the counterweight unit 6 is formed with two first grooves 621 (only one is visible from FIG. 2) at the left and right ends thereof, respectively. Each of the couplers 63 includes a block body 631, and a protruding pin 632 connected to the block body 631 and extending removably and transversely into a corresponding one of the first grooves 621 in the bottom bar 62. The block body 631 is formed with a second groove 633 for engaging removably the lower end of the corresponding one of the left and right side bars 61. Therefore, the lower end of each of the left and right side bars 61 is first inserted downwardly into the second groove 633 in the block body 631 of the corresponding one of the couplers 63, and the upper end of each of the left and right side bars 61 is subsequently pressed forwardly into the corresponding one of the slots 41 in the lowermost lifting rod 4 such that the upper end is clamped at a periphery thereof. Please note that FIG. 2 is a view of the lowermost shielding section 32 and the counterweight unit 6 from the back. In this embodiment, the bottom bar 62 of the counterweight unit 6 is in the form of a hollow rod having access openings at opposite ends thereof. The access openings serve the same purposes as the first grooves 621.

Moreover, each of the vertically extending flaps 322 includes a coupling portion 324 coupled removably to the main shielding part 321, and a folding portion 325 extending between the coupling portion 324 and the corresponding one of the left and right edges. The folding portion 325 is folded to form the corresponding vertically extending pocket 323 when the coupling portion 324 is connected to the main shielding part 321. The lowermost shielding section 32 further includes two coupling units 326, each of which includes a first coupling member 327 disposed on the coupling portion 324 of a corresponding one of the vertically extending flaps 322, and a second coupling member 328 disposed on a back surface of the main shielding part 321 and coupled removably to the first coupling member 327. The folding portion 325 of each of the vertically extending flaps 322 is folded to form the corresponding vertically extending pocket 323 when the first and second coupling members 327, 328 of the corresponding one of the coupling units 326 are coupled to each other. The first coupling member 327 of each of the coupling units 326 can be one of a hook fastener and a loop fastener of a hook-and-loop fastening set, and the second coupling member 328 of each of the coupling units 326 is the other one of the hook and loop fasteners of the hook-and-loop fastening set. The hook and look fasteners can be fastened removably to each other. As best illustrated in FIG. 2, in the first preferred embodiment, the first coupling member 327 of each of the coupling units 326 is a hook fastener, and the second coupling member 328 of each of the coupling units 326 is a loop fastener. Therefore, when the first and second coupling members 327, 328 of each of the coupling units 326 are engaged to each other, the folding portion 325 of the corresponding one of the vertically extending flaps 322 is folded to form the corresponding vertically extending pocket 323. On the other hand, when the first and second coupling members 327, 328 of each of the coupling units 326 are disengaged from each other, the folding portion 325 of the corresponding one of the vertically extending flaps 322 can be unfolded so as to expose the corresponding one of the left and right side bars 61.

Referring again to FIG. 1, the furling controller 5 includes a winding mechanism 51 mounted on the top frame member 2, and at least one pull cord 53 connected to the winding mechanism 51 and to the lifting rods 4 in sequence. The pull cord 53 has a distal end retained at a top of the lowermost shielding section 32. The pull cord 53 can be wound upwardly when the winding mechanism 51 applies a winding force thereto, and can be pulled downwardly when the bottom bar 62 of the counterweight unit 6 is operated to apply a downward pulling force thereto. In addition, the blind device further includes a positioning unit 7 including a plurality of ring components 71. Each of the ring components 71 is disposed at a junction of a corresponding adjacent pair of the shielding sections 31 of the screen body 3. The pull cord 53 passes in sequence through the ring components 71 such that the distal end thereof is retained at a lowermost one of the ring components 71, which is disposed at the top of the lowermost shielding section 32. In this embodiment, the winding mechanism 51 includes two of the pull cords 53, and the positioning unit 7 includes two sets of the ring components 71, where each set includes four of the ring components 71. Each of the pull cords 53 passes in sequence through the ring components 71 in a corresponding set such that the distal end thereof is retained at a lowermost one of the ring components 71 in the corresponding set.

When the blind device is in use, furling and unfurling of the screen body 3 can be conducted by pushing the bottom bar 62 upward or pulling the bottom bar 62 downward. In particular, upward movement of the bottom bar 62 transmits to upward movement of the left and right side bars 61, resulting in upward movement of the lowermost shielding section 32 of the screen body 3, which in turn folds the shielding sections 31 in sequence from bottom to top. On the other hand, downward movement of the bottom bar 62 results in downward movement of the lowermost shielding section 32 of the screen body 3, which in turn unfolds the shielding sections 31 in sequence from top to bottom. Since the gravitational force applied by the counterweight unit 6 on the pull cords 53 is selected to balance the winding force applied by the winding mechanism 51 on the pull cords 53, when the bottom bar 62 is held at an arbitrary height, the screen body 3 can be maintained in a state where a desired area of the screen body 3 is unfurled in a conventional manner. Since the furling/unfurling mechanism of the blind device does not differ from that of the conventional blind device, and should be well known to those skilled in the art, further details of the same are omitted herein for the sake of brevity.

Primarily, to reduce packaging material and storage space requirements of the blind device, the side bars 61 are designed to be removable from the vertically extending pockets 323 so as to convert the counterweight unit 6 from the screen-stretching state, as best shown in FIG. 1, to the screen-foldable state, as best shown in FIG. 4. In particular, to convert the counterweight unit 6 from the screen-stretching state to the screen-foldable state, the first and second coupling members 327, 328 of each of the coupling units 326 are disengaged from each other so as to permit unfolding of the folding portion 325 of the corresponding one of the vertically extending flaps 322 such that the corresponding one of the left and right side bars 61 is exposed and can be removed from the lowermost shielding section 32. Subsequently, the top ends of the left and right side bars 61 are disengaged from the slots 41 in the lowermost lifting rod 4, and the lower ends of the left and right side bars 61 are disengaged respectively from the second grooves 633 in the block bodies 631 of the couplers 63. Finally, the lifting rods 4 are removed from the horizontally extending rod-receiving pockets 33, respectively, and the bottom bar 62 is removed from the horizontally extending pocket 34. At this time, the lowermost shielding section 32 of the screen body 3 is no longer supported by the left and right side bars 61, and permits free furling thereof. Consequently, as soon as the left and right side bars 61, the bottom bar 62, and the lifting rods 4 are removed from the corresponding vertically extending pocket 323, horizontally extending pocket 34, and horizontally extending rod-receiving pockets 33, the shielding sections 31 of the screen body 3 can be folded in sequence, resulting in a relatively compact blind device, which is convenient for both storage and transport, and in turn reduces packaging material, transport cost, and storage space as compared to the prior art.

In another aspect, with the design of the vertically extending flaps 322, where the coupling portion 324 thereof is coupled removably to the main shielding part 321, quick and accurate assembly and disassembly of the left and right side bars 61 to the lowermost lifting rod 4 and the bottom bar 62 is facilitated. In addition, when the vertically extending flaps 322 are coupled to the main shielding part 321, the left and right side bars 61 are fully concealed in the vertically extending pockets 323 formed respectively thereby.

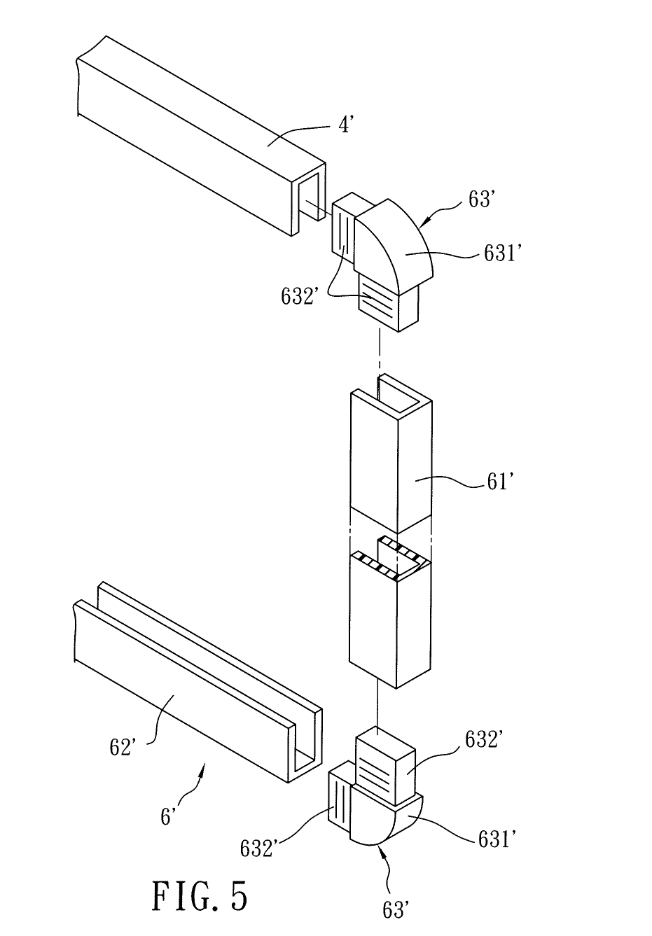

As shown in FIG. 5, the second preferred embodiment of a blind device according to the present invention differs from the first preferred embodiment in the configuration of the counterweight unit 6′ and the lowermost lifting rod 4′. In this embodiment, each of the bottom bar 62′ and the left and right side bars 61′ of the counterweight unit 6′ has a U-shaped structure. Openings of the left and right side bars 61′ are registered to each other. Each of the couplers 63′ is clamped removably by the lower end of the corresponding one of the left and right side bars 61′ and the corresponding one of the left and right ends of the bottom bar 62′. Each of the couplers 63′ includes a fan-shaped main body 631′ and two insert portions 632′ that extend from the main body 631′ and that are angularly spaced apart from each other at a right angle. Each of the insert portions 632′ is clamped removably by one of the bottom bar 62′, the left side bar 61′ and the right side bar 61′. The lowermost lifting rod 4′ has a U-shaped structure with an opening registered with an opening of the bottom bar 62′. The counterweight unit 6′ further includes another pair of the couplers 63′, each of which connects removably a corresponding end of the lowermost lifting rod 4′ to the upper end of a corresponding one of the left and right side bars 61′. To disassemble the left and right side bars 61′ from the bottom bar 62′ and the lowermost lifting rod 4′ , each of the left and right bars 61′ is pulled sideways such that the upper and lower ends thereof disengage from corresponding ones of the couplers 63′. Eventually, the couplers 63′ can be disengaged from the bottom bar 62′ and the lowermost lifting rod 4′ when disassembling the blind device. Therefore, the second preferred embodiment of the blind device according to the present invention is also capable of providing easy assembly and disassembly thereof, and achieves the advantages of reducing packaging material, and transport and storage space requirements of the blind device.

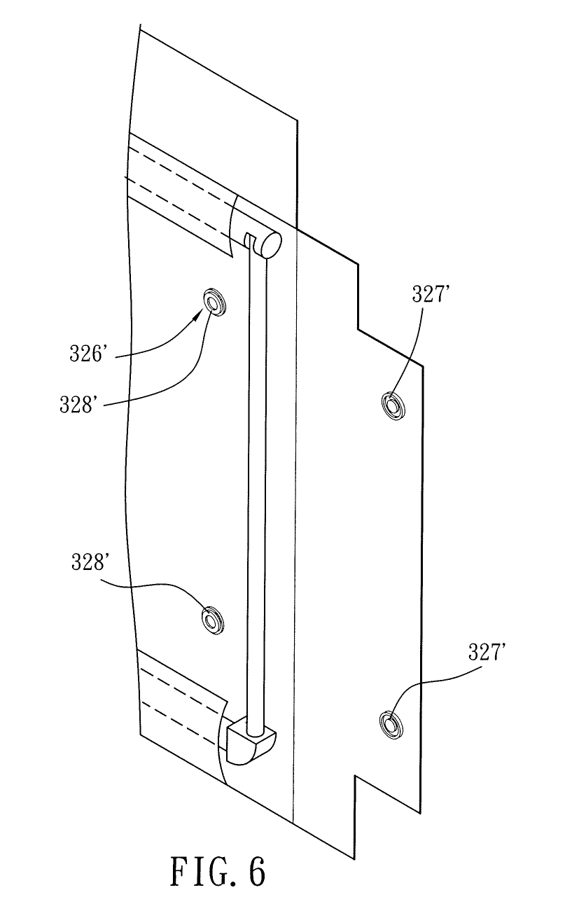

As shown in FIG. 6, the third preferred embodiment of a blind device according to the present invention differs from the first preferred embodiment in the coupling units 326′. In this embodiment, the first coupling member 327′ of each of the coupling units 326′ (only one is visible in FIG. 6) is one of a male fastener and a female fastener of a button fastening set, and the second coupling member 328′ of each of the coupling units 326′ is the other one of the male and female fasteners of the button fastening set. In particular, the first coupling member 327′ is a male fastener and the second coupling members 328′ is a female fastener of a button fastening set.

In sum, when it is desired to reduce packaging material and storage space requirements of the blind device, the counterweight unit 6 (6′) is converted from the screen-stretching state (as shown in FIG. 1) to the screen-foldable state (as shown in FIG. 4) by removing the left and right side bars 61 (61′). To this end, the coupling portion 324 of each of the vertically extending flaps 322 is coupled removably to the main shielding part 321 to facilitate quick and accurate disassembly of the left and right side bars 61 (61′) from the bottom bar 62 (62′) and the lowermost lifting rod 4 (4′) such that the shielding sections 31 of the screen body 3 can be folded in sequence to reduce the size thereof, thereby reducing packaging material, transport cost, and storage space as compared to the prior art.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A blind device comprising:
a top frame member;
a flexible screen body that can be furled and unfurled and that has a top end connected to said top frame member, said screen body including a plurality of shielding sections arranged in a vertical column, adjacent ones of said shielding sections being interconnected;
a plurality of lifting rods, each of which is retained at a junction of a corresponding adjacent pair of said shielding sections of said screen body;
a furling controller including a winding mechanism mounted on said top frame member, and at least one pull cord connected to said winding mechanism and to said lifting rods in sequence, said pull cord having a distal end retained at a top of a lowermost one of said shielding sections, said winding mechanism applying a winding force on said pull cord; and
a counterweight unit provided on said lowermost one of said shielding sections to balance the winding force of said winding mechanism;
said counterweight unit including vertically extending left and right side bars provided respectively at left and right edges of said lowermost one of said shielding sections, and a horizontally extending bottom bar retained at a bottom edge of said lowermost one of said shielding sections and disposed to transmit an upward pushing force on said bottom bar to said left and right side bars;
said counterweight unit being convertible from a screen-stretching state, where said lowermost one of said shielding sections is stretched by said left and right side bars, and a screen-foldable state, where said counterweight unit permits folding of said lowermost one of said shielding sections in a vertical direction;
said lowermost one of said shielding sections including a main shielding part that has said left and right edges, and a pair of vertically extending flaps extending respectively from said left and right edges, each of said vertically extending flaps being coupled removably to said main shielding part and forming a corresponding vertically extending pocket at a corresponding one of said left and right edges when coupled to said main shielding part, said left and right side bars being received respectively and removably in said vertically extending pockets such that said left and right side bars stretch said lowermost one of said shielding sections when received in said vertically extending pockets and permit folding of said lowermost one of said shielding sections in the vertical direction when removed from said vertically extending pockets.

2. The blind device as claimed in claim 1, wherein each of said vertically extending flaps includes a coupling portion coupled removably to said main shielding part, and a folding portion extending between said coupling portion and the corresponding one of said left and right edges, said folding portion being folded to form said corresponding vertically extending pocket when said coupling portion is connected to said main shielding part.

3. The blind device as claimed in claim 2, wherein said lowermost one of said shielding sections further includes two coupling units, each of which includes a first coupling member disposed on said coupling portion of a corresponding one of said vertically extending flaps, and a second coupling member disposed on a back surface of said main shielding part and coupled removably to said first coupling member, said folding portion of each of said vertically extending flaps being folded to form said corresponding vertically extending pocket when said first and second coupling members of the corresponding one of said coupling units are coupled to each other.

4. The blind device as claimed in claim 3, wherein said first coupling member of each of said coupling units is one of a hook fastener and a loop fastener of a hook-and-loop fastening set, and said second coupling member of each of said coupling units is the other one of said hook and loop fasteners of said hook-and-loop fastening set.

5. The blind device as claimed in claim 3, wherein said first coupling member of each of said coupling units is one of a male fastener and a female fastener of a button fastening set, and said second coupling member of each of said coupling units is the other one of said male and female fasteners of said button fastening set.

6. The blind device as claimed in claim 1, wherein:
said screen body is provided with a plurality of horizontally extending rod-receiving pockets, each of which is disposed at a junction of a corresponding adjacent pair of said shielding sections for receiving a corresponding one of said lifting rods therein;
said lowermost one of said shielding sections of said screen body is provided with a horizontally extending pocket at said bottom edge thereof for receiving said bottom bar therein; and
said blind device further comprises a positioning unit including a plurality of ring components, each of said ring components being disposed at a junction of a corresponding adjacent pair of said shielding sections of said screen body, said pull cord passing in sequence through said ring components such that said distal end thereof is retained at a lowermost one of said ring components, which is disposed at said top of said lowermost one of said shielding sections.

7. The blind device as claimed in claim 1, wherein said counterweight unit further includes a pair of couplers, each of which connects removably a corresponding one of left and right ends of said bottom bar to a lower end of a corresponding one of said left and right side bars.

8. The blind device as claimed in claim 7, wherein:
said bottom bar of said counterweight unit is formed with two first grooves at said left and right ends thereof, respectively;
each of said couplers includes a block body formed with a second groove for engaging removably said lower end of the corresponding one of said left and right side bars, and a protruding pin extending removably into a corresponding one of said first grooves in said bottom bar; and
a lowermost one of said lifting rods is formed with two slots at opposite ends thereof, each of said slots engaging removably an upper end of a corresponding one of said left and right side bars opposite to said lower end.

9. The blind device as claimed in claim 7, wherein each of said bottom bar and said left and right side bars has a U-shaped structure, each of said couplers being clamped removably by said lower end of the corresponding one of said left and right side bars and said corresponding one of said left and right ends of said bottom bar.

10. The blind device as claimed in claim 9, wherein each of said couplers includes a fan-shaped main body and two insert portions that extend from said main body and that are angularly spaced apart from each other at a right angle, each of said insert portions being clamped removably by one of said bottom bar, said left side bar and said right side bar.

11. The blind device as claimed in claim 10, wherein a lowermost one of said lifting rods has a U-shaped structure, said counterweight unit further including another pair of said couplers, each of which connects removably a corresponding end of said lowermost one of said lifting rods to an upper end of a corresponding one of said left and right side bars opposite to said lower end.
